(19) United States
(12) Patent Application Publication
(10) Pub. No.: US 2026/0020551 A1
(43) Pub. Date: Jan. 22, 2026

(54) Weighted Fishing Bobber Device

(71) Applicant: Nathan Lamphear, Eucha, OK (US)

(72) Inventor: Nathan Lamphear, Eucha, OK (US)

(21) Appl. No.: 19/081,008

(22) Filed: Mar. 17, 2025

Related U.S. Application Data
(60) Provisional application No. 63/672,808, filed on Jul. 18, 2024.

(51) Int. Cl. A01K 93/00

(52) U.S. Cl. CPC A01K 93/00

(57) ABSTRACT

A weighted fishing bobber device is provided. The device is designed to enhance casting distance, stability, and bite detection, thereby improving fishing efficiency. The device comprises a slip bobber body with an aerodynamic tapered cylindrical shape to minimize air resistance. A hydrophobic coating may be applied to reduce drag in air and water. Stability and momentum of the device optimized through at least one weighted sinker. The device is also comprised of a three-way swivel that minimizes tangling and enhances functionality. The device may also be comprised of plastic beads that generate sound to attract fish, act as a buffer to protect structural components, and may feature luminescent properties for night fishing. Markings on the bobber body improve usability, including reflective indicators for low-light visibility and depth measurement indicators for bait positioning.

### CROSS-REFERENCE TO RELATED APPLICATION

The present application claims priority to, and the benefit of, U.S. Provisional Application No. 63/672,808, which was filed on Jul. 18, 2024, and is incorporated herein by reference in its entirety.

### FIELD OF THE INVENTION

The present invention relates generally to the field of fishing bobbers. More specifically, the present invention relates to a fishing bobber that enhances casting distance, stability, and bite detection. Accordingly, the present disclosure makes specific reference thereto. Nonetheless, it is to be appreciated that aspects of the present invention are also equally applicable to other like applications, devices, and methods of manufacture.

### BACKGROUND

Maximizing the flight and distance of a fishing cast is crucial for anglers attempting to reach fish located far from the shoreline. When casts are too short, lures and bait are more likely to become entangled in underwater structures, reducing efficiency and increasing the risk of losing fishing tackle. Additionally, shorter casts can prevent anglers from accessing deeper waters where certain fish species are more abundant. Traditional fishing bobbers often lack the necessary weight and aerodynamic design to achieve long-distance casting, particularly in windy conditions. Anglers may also struggle with bite detection when using conventional bobbers, as inadequate stability and responsiveness can obscure subtle movements. Furthermore, fishing in various environmental conditions, such as murky water or low-light settings, requires bobbers with enhanced visibility and tracking features. Without these improvements, the fishing experience can be less productive and enjoyable.

Therefore, there exists a long-felt need in the art for a weighted fishing bobber device that maximizes casting distance to allow anglers to reach fish in deeper waters and farther locations. There also exists a long-felt need in the art for a weighted fishing bobber device that improves stability and responsiveness on the water's surface to enhance bite detection. Moreover, there exists a long-felt need in the art for a weighted fishing bobber device that incorporates aerodynamic and durable materials to maintain long-distance casts in varying weather conditions while increasing the overall effectiveness and longevity of the device.

The subject matter disclosed and claimed herein, in one embodiment thereof, comprises a weighted fishing bobber device. The device is designed to enhance casting distance, stability, and bite detection, thereby improving fishing efficiency. The device comprises a slip bobber body with an aerodynamic tapered cylindrical shape to minimize air resistance. A hydrophobic coating may be applied to reduce drag in air and water. Stability and momentum of the device are optimized through at least one weighted sinker. The device is also comprised of a three-way swivel that minimizes tangling and enhances functionality. The device may also be comprised of plastic beads that generate sound to attract fish, act as a buffer to protect structural components, and may feature luminescent properties for night fishing. Markings on the bobber body improve usability, including reflective indicators for low-light visibility and depth measurement indicators for bait positioning. These elements, combined with durable materials and a functional design, ensure the device maximizes casting distance, reduces snagging, and enhances bite detection for use in diverse fishing environments.

In this manner, the weighted fishing bobber device of the present invention accomplishes all the foregoing objectives and provides a fishing bobber with an aerodynamic shape to minimize air resistance and maximize flight distance. The addition of the weighted component ensures stability during casting and maintains an upright position in the water, thereby improving bite detection. The use of durable, corrosion-resistant materials, including stainless steel components and hydrophobic coatings, enhances the longevity and adaptability of the device across different fishing environments. Furthermore, visual enhancements such as reflective markings and luminescent beads improve visibility in low-light conditions, allowing anglers to track movements effectively. By addressing these needs, the weighted fishing bobber device provides a practical solution for increasing casting efficiency, reducing the risk of snags, and enhancing the overall fishing experience.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a weighted fishing bobber device. The weighted fishing bobber device is designed to improve casting distance, stability, and bite detection for more efficient fishing. By enabling long-distance casts while maintaining buoyancy and responsiveness, the device reduces the likelihood of bait snagging on underwater structures. The device is comprised of a slip bobber body that is preferably an aerodynamic, tapered cylindrical shape to minimize air resistance and maximize flight distance. A hydrophobic coating may be applied to reduce drag in air and water. For usability, the bobber body may feature markings, which may be reflective for low-light visibility or include depth measurement indicators to assist anglers in gauging bait position.

For enhanced stability and momentum during casting, the device is comprised of at least one egg sinker or other weight, preferably one ounce or more. This weight also helps keep the bobber upright on the water's surface and may be made of lead, tungsten, or similar dense materials. In some embodiments, the weight is adjustable, allowing anglers to modify casting performance and buoyancy.

A stainless steel cable is included and secured with a double barrel crimp for a strong, slip-resistant connection. The cable may vary in length and thickness to accommodate different fishing styles and may be sheathed in a protective coating to reduce abrasion and extend durability. A three-way swivel is attached to the cable, serving as a reinforced attachment point that minimizes tangling and enhances durability.

The device may also include at least one plastic bead, which can create subtle clicking noises to attract fish. The bead may be brightly colored for visibility in murky water and, in some embodiments, luminescent for night fishing. The beads also serve as a buffer to protect knots and structural components.

The combination of aerodynamic design, durable materials, and functional enhancements ensures that the weighted fishing bobber device maximizes casting distance, reduces snag risks, and improves bite detection. The device is further suitable for various fishing environments, including lakes, rivers, coastal waters, and deep-sea applications.

Accordingly, the weighted fishing bobber device of the present invention is particularly advantageous as it provides a fishing bobber with an aerodynamic shape to minimize air resistance and maximize flight distance. The addition of the weighted component ensures stability during casting and maintains an upright position in the water, thereby improving bite detection. The use of durable, corrosion-resistant materials, including stainless steel components and hydrophobic coatings, enhances the longevity and adaptability of the device across different fishing environments. Furthermore, visual enhancements such as reflective markings and luminescent beads improve visibility in low-light conditions, allowing anglers to track movements effectively. By addressing these needs, the weighted fishing bobber device provides a practical solution for increasing casting efficiency, reducing the risk of snags, and enhancing the overall fishing experience.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a weighted fishing bobber device of the present invention in accordance with the disclosed architecture;

FIG. 2 illustrates an enhanced side view of a weight and a bed of one potential embodiment of a weighted fishing bobber device of the present invention in accordance with the disclosed architecture; and

FIG. 3 illustrates an enhanced side view of a cable and a swivel of one potential embodiment of a weighted fishing bobber device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a weighted fishing bobber device that maximizes casting distance to allow anglers to reach fish in deeper waters and farther locations. There also exists a long-felt need in the art for a weighted fishing bobber device that improves stability and responsiveness on the water's surface to enhance bite detection. Moreover, there exists a long-felt need in the art for a weighted fishing bobber device that incorporates aerodynamic and durable materials to maintain long-distance casts in varying weather conditions while increasing the overall effectiveness and longevity of the device.

The present invention, in one exemplary embodiment, is comprised of a weighted fishing bobber device. The weighted fishing bobber device is designed to enhance casting distance, stability, and bite detection, improving overall fishing efficiency. By facilitating long-distance casts while maintaining buoyancy and responsiveness, the device helps reduce the risk of bait snagging on underwater structures. The device is comprised of a slip bobber body, which is preferably an aerodynamic, tapered cylindrical shape to reduce air resistance and maximize flight distance. A hydrophobic coating may be applied to minimize drag in both air and water. For improved usability, the bobber body may include markings that are reflective for visibility in low-light conditions or feature depth measurement indicators to assist anglers in determining bait position.

For increased stability and momentum during casting, the device is comprised of at least one egg sinker or other weight. The weight also maintains the bobber's upright position on the water's surface and may be constructed from lead, tungsten, or similar dense materials. In some embodiments, the weight is adjustable, allowing anglers to modify casting performance and buoyancy.

A stainless steel cable secured with a double barrel crimp is also included to ensure a strong, slip-resistant connection. The cable may vary in length and thickness to support different fishing techniques and may be coated for abrasion resistance and durability. A three-way swivel is attached to the cable, providing a reinforced attachment point that minimizes tangling and enhances durability.

The device may also incorporate at least one plastic bead, which can produce subtle clicking sounds to attract fish. The bead may be brightly colored for visibility in murky water and, in some embodiments, luminescent for night fishing. Additionally, the bead acts as a buffer to protect knots and structural components.

The integration of an aerodynamic design, durable materials, and functional enhancements ensures that the weighted fishing bobber device maximizes casting distance, minimizes the risk of snags, and improves bite detection. The device is well-suited for use in various fishing environments, including lakes, rivers, coastal waters, and deep-sea applications.

As a result, the weighted fishing bobber device offers significant advantages, including an aerodynamic shape to minimize air resistance and enhance flight distance. The weighted component ensures stability during casting and helps maintain an upright position in the water, improving bite detection. The use of corrosion-resistant materials, such as stainless steel components and hydrophobic coatings, increases durability and adaptability across different fishing conditions. Additionally, visual enhancements like reflective markings and luminescent beads improve visibility in low-light settings, allowing anglers to track movement effectively. By addressing these key fishing challenges, the weighted fishing bobber device enhances casting efficiency, reduces snagging risks, and improves the overall fishing experience.

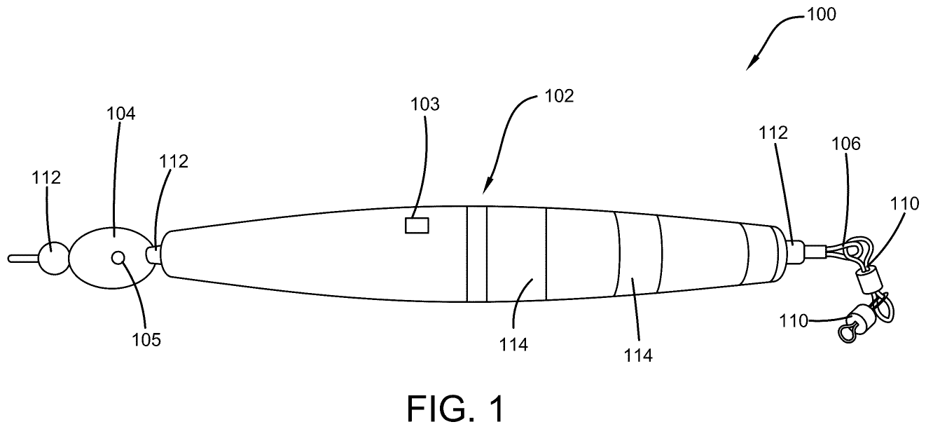

Referring initially to the drawings, FIG. 1 illustrates a side view of one potential embodiment of a weighted fishing bobber device 100 of the present invention in accordance with the disclosed architecture. The weighted fishing bobber device 100 is designed to enhance casting distance, improve stability, and increase bite detection, making fishing more efficient and effective. More specifically, because anglers often struggle to reach fish located far from the shoreline, and shorter casts increase the likelihood of bait becoming snagged on underwater structures, the device 100 addresses these challenges by enabling long-distance casts while maintaining buoyancy, stability, and responsiveness.

The weighted fishing bobber device 100 is comprised of a slip bobber body 102. The body 102 may be made of a material that may be hollow and/or buoyant, such as, but not limited to, high-impact plastic, composite materials, or foam. The body 102 is preferably comprised of an aerodynamic shape that is preferably, but not limited to, a tapered cylindrical shape. This shape reduces air resistance, ensuring maximum flight distance even in moderate wind conditions. The surface of the body 102 may also be treated with a hydrophobic coating 103 to reduce drag when passing through the air or water.

In different embodiments, the body 102 may be any type or style of bobber body to accommodate various fishing techniques and environmental conditions. The body 102 may be configured as a traditional oval slip bobber, a pencil bobber, a cigar-shaped bobber, a round or ball-style bobber, or a teardrop bobber. Additionally, in certain embodiments, the body 102 may be a segmented body to create movement in response to water currents, simulating natural bait motion.

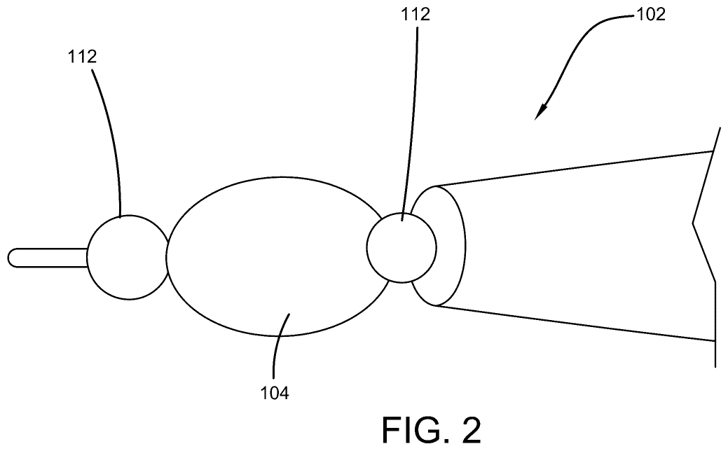

To optimize stability and increase momentum during casting, the device 100 is comprised of at least one egg sinker 104 (or other weight) that is preferably at least one ounce in weight, as seen in FIG. 2. The egg sinker 104 also serves to keep the body 102 upright on the water's surface. The egg sinker 104 may be made of lead, tungsten, or other dense materials suitable for fishing applications. In alternative embodiments, the weight is an adjustable weight, allowing anglers to modify the casting performance and buoyancy of the device 100 by adding or removing individual weight components. The weight 104 may also be coated with a corrosion-resistant material/coating 105 to improve longevity in saltwater environments.

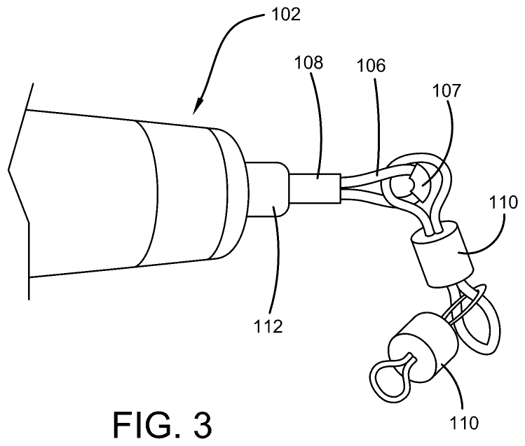

The device 100 is further comprised of a stainless steel cable 106 secured using a double barrel crimp 108 (as seen in FIG. 3), ensuring a strong and secure connection that prevents slippage under tension. The stainless steel cable 106 may vary in length and thickness to accommodate different fishing styles, including deep-water fishing or surface-level fishing. Additionally, the stainless steel cable 106 may be sheathed in a protective coating 107 to reduce abrasion and extend durability.

A three-way swivel 110 is attached to the stainless steel cable 106 (as seen in FIG. 3), serving as a reinforced attachment point that minimizes tangling and enhances the overall durability and functionality of the device 100. The three-way swivel 110 may be made of stainless steel or other corrosion-resistant metals to ensure long-term performance. In some embodiments, the swivel 110 is a ball-bearing swivel to provide smooth rotation and reduce line twist.

To further improve functionality, the device 100 may be comprised of at least one plastic bead 112. The plastic bead 112 may serve multiple purposes, including producing subtle clicking noises when making contact with other beads or other areas of the device 100, which may help attract certain fish species. The plastic bead 112 may be brightly colored to enhance visibility in murky water, making it easier for anglers to track the movement of the device 100. In some embodiments, the plastic bead 112 may be luminescent/phosphorescent to improve visibility during night fishing.

The plastic bead 112 also functions as a buffer for knots, crimps, and other structural components of the device 100 (as seen in FIG. 2 and FIG. 3), preventing damage and increasing overall durability. The plastic bead 112 may be available in various sizes and materials, including hard plastic, rubberized coatings, or ceramic variants, each providing different levels of cushioning and noise production. In some configurations, multiple beads may be stacked or arranged in a sequence to create a more distinct clicking sound, further enhancing their fish-attracting capability.

For enhanced usability, the body 102 may include various markings 114. In one embodiment, the markings 114 are reflective, improving visibility in low-light conditions such as dawn, dusk, or night fishing. In a further embodiment, the markings 114 are depth measurement indicators that allow anglers to estimate the position of their bait in the water, providing a convenient reference for depth adjustments. The markings 114 may be printed, embossed, or integrated into the body 102 using paint, stickers, or other application methods.

In additional embodiments, the markings 114 may include numerical depth indicators, contrasting color bands, and/or raised texture patterns for tactile identification. The markings 114 may be resistant to fading or wear, ensuring long-term visibility and accuracy even after prolonged exposure to water and UV light.

The combination of aerodynamic design, durable materials, and functional enhancements ensures that the weighted fishing bobber device 100 maximizes casting distance, reduces the risk of snags, and improves bite detection. The weighted fishing bobber device 100 may be used in various fishing environments, including lakes, coastal waters, rivers, and deep-sea applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “weighted fishing bobber device” and “device” are interchangeable and refer to the weighted fishing bobber device 100 of the present invention.

Notwithstanding the foregoing, the weighted fishing bobber device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the weighted fishing bobber device 100 as shown in the FIGS. are for illustrative purposes only, and that many other sizes and shapes of the weighted fishing bobber device 100 are well within the scope of the present disclosure. Although the dimensions of the weighted fishing bobber device 100 are important design parameters for user convenience, the weighted fishing bobber device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A weighted fishing bobber device comprising:
a bobber body;
a weight attached to the bobber body;
a cable;
a swivel attached to the cable; and
a bead positioned along the stainless steel cable.

2. The weighted fishing bobber device of claim 1, wherein the bobber body is comprised of a hydrophobic coating.

3. The weighted fishing bobber device of claim 1, wherein the weight is comprised of an adjustable weight.

4. The weighted fishing bobber device of claim 1, wherein the swivel is comprised of a three-way swivel.

5. The weighted fishing bobber device of claim 1, wherein the bead is phosphorescent.

6. The weighted fishing bobber device of claim 1, wherein the bobber body is comprised of an oval slip bobber, a pencil bobber, a cigar-shaped bobber, a round bobber, a ball-style bobber, or a teardrop bobber.

7. A weighted fishing bobber device comprising:
a bobber body that has a tapered cylindrical shape;
a weight attached to the bobber body;
a cable;
a swivel attached to the cable; and
a bead positioned along the stainless steel cable.

8. The weighted fishing bobber device of claim 7, wherein the swivel is comprised of a ball-bearing swivel.

9. The weighted fishing bobber device of claim 7, wherein the bobber body is comprised of an oval slip bobber, a pencil bobber, a cigar-shaped bobber, a round bobber, a ball-style bobber, or a teardrop bobber.

10. The weighted fishing bobber device of claim 7, wherein the weight is comprised of an adjustable weight.

11. The weighted fishing bobber device of claim 7, wherein the cable is comprised of a protective coating.

12. A weighted fishing bobber device comprising:
a bobber body that has a tapered cylindrical shape, the bobber body comprised of a marking;
a weight attached to the bobber body;
a cable;
a swivel attached to the cable; and
a bead positioned along the stainless steel cable.

13. The weighted fishing bobber device of claim 12, wherein the weight is comprised of a corrosion-resistant coating.

14. The weighted fishing bobber device of claim 12, wherein the marking is comprised of a depth measurement indicator.

15. The weighted fishing bobber device of claim 14, wherein the marking is comprised of a color band.

16. The weighted fishing bobber device of claim 14, wherein the marking is comprised of a numerical depth indicator.

17. The weighted fishing bobber device of claim 12, wherein the bobber body is comprised of an oval slip bobber, a pencil bobber, a cigar-shaped bobber, a round bobber, a ball-style bobber, or a teardrop bobber.

18. The weighted fishing bobber device of claim 14, wherein the marking is comprised of a pattern.

19. The weighted fishing bobber device of claim 12, wherein the weight is comprised of an adjustable weight.

20. The weighted fishing bobber device of claim 12, wherein the cable is comprised of a protective coating.
